(19) United States
(12) Patent Application Publication
(10) Pub. No.: US 2026/0284813 A1
(43) Pub. Date: Sep. 24, 2026

(54) VERTICAL LIFT FOR ROBOTIC WORKSTATION

(71) Applicant: ARRAYCORE AUTOMATION, LLC, GRAND MOUND, IA (US)

(72) Inventors: Chris MANGELSEN, Charlotte, IA (US); Richard Dean ROHRET, Bettendorf, IA (US); Scott N. WOTEN, Long Grove, IA (US)

(21) Appl. No.: 19/083,011

(22) Filed: Mar. 18, 2025

(51) Int. Cl. B23Q 1/48

(52) U.S. Cl. CPC B23Q 1/48

(57) ABSTRACT

A workpiece support table proximate to a robotic arm for supporting the workpiece, and a vertical lifting system coupled to the workpiece support table. The vertical lifting system provides a first rotational degree of freedom elevating the workpiece support table by tilting the workpiece support table relative to the robotic arm, and a second rotational degree of freedom rotating the workpiece support table about an axis extending laterally across the workpiece support table.

### TECHNICAL FIELD

The present disclosure relates generally to robotic workstations for welding workpieces, and more particularly to a robotic welding system incorporating a workpiece support table configured for multi-axis positional adjustment.

### BACKGROUND INFORMATION

Robotic workstations for welding have become integral to modern manufacturing, particularly in industries such as agriculture, automotive, aerospace, and heavy machinery production, where precision and repeatability are paramount. These workstations typically include a robotic arm equipped with a welding tool, such as a gas metal arc welding torch or a laser welding head, positioned adjacent to a support surface or table on which workpieces are secured during the welding process. The robotic arm is programmed to execute weld paths across the workpieces, often integrating sensors and control systems to ensure accuracy and consistency.

A common configuration in such workstations involves a welding table positioned proximate to the robotic arm, designed to hold workpieces in a stable orientation during welding. To facilitate loading and unloading of workpieces, some conventional systems employ a table that can be raised and lowered vertically along a linear axis. For example, a typical prior art design features a welding table supported by a lifting mechanism, such as a screws or hydraulic or pneumatic actuators, which adjusts the table height relative to the robotic arm. This vertical adjustability aims to improve ergonomic access for operators tasked with placing or removing workpieces, particularly in high-volume production environments.

The cost of implementing and maintaining such workstations presents a challenge. The lifting mechanisms employed in vertically adjustable tables, such as hydraulic systems or heavy-duty linear actuators, often require robust structural components and sophisticated control systems to ensure stability and precision under the loads imposed by workpieces and welding forces. These elements contribute to elevated manufacturing and operational expenses, rendering such systems less economically viable for smaller-scale operations or applications requiring frequent reconfiguration.

Thus, while robotic welding workstations with vertically adjustable tables address certain ergonomic and operational needs, their limitations in reach and cost highlight a need for improved designs in the field of automated welding systems.

### SUMMARY

Disclosed is an apparatus for supporting workpieces in a robotic welding workstation, comprising a frame and a workpiece support table operatively coupled to the frame, configured to support a workpiece within reach of a robotic arm and be able to rotate large parts and clear the floor. The apparatus includes a driven linear mechanism pivotally coupled to the frame and connected to the workpiece support table, configured to tilt the workpiece support table about a pivot point to raise and lower the workpiece support table relative to the frame. Additionally, a motorized rotational system is coupled to the workpiece support table, configured to rotate the workpiece support table about a minor axis extending laterally across the workpiece support table. The driven linear mechanism and motorized rotational system cooperate to position the workpiece support table in a plurality of orientations for welding by the robotic arm.

In certain embodiments, the driven linear mechanism comprises a ball screw assembly including a ball screw rotatably supported by a lower pivot mount affixed to the frame, a nut threadedly engaged with the threaded shaft, and a connecting bracket linking the nut to the workpiece support table, with a first servo motor operatively coupled to the ball screw to drive the nut linearly, thereby tilting the workpiece support table about the pivot point. The motorized rotational system may comprise a rotational mount disposed on a lateral side of the workpiece support table, a shaft extending along the minor axis and coupled to the rotational mount, and a servo motor to rotate the shaft.

The invention further encompasses a robotic workstation for processing workpieces, comprising a robotic arm configured to perform a processing operation on a workpiece, a workpiece support table proximate to the robotic arm for supporting the workpiece, and a vertical lifting system coupled to the workpiece support table. The vertical lifting system provides a first rotational degree of freedom elevating the workpiece support table by tilting the workpiece support table relative to the robotic arm, and a second rotational degree of freedom rotating the workpiece support table about an axis extending laterally across the workpiece support table.

In some configurations, the first rotational degree of freedom is positioned outside a footprint of the workpiece support table and may include a frame and a lower pivot mount connected to the frame, with a driven linear mechanism operatively connected to the workpiece support table and the lower pivot mount. This driven linear mechanism may comprise a ball screw assembly with a ball screw rotatably supported by the lower pivot mount affixed to the frame, a nut threadedly engaged with the threaded shaft, and a connecting bracket linking the nut to the workpiece support table.

The second rotational degree of freedom may be facilitated by a rotational mechanism coupled to the workpiece support table, aligned with a minor axis extending laterally across the workpiece support table, comprising a rotational mount disposed on a lateral side of the workpiece support table, a shaft extending along the minor axis and coupled to the rotational mount, and a servo motor to rotate the shaft.

### BRIEF DESCRIPTION OF THE DRAWINGS

These and other features and advantages of the present invention will be better understood by reading the following detailed description, taken together with the drawings wherein:

FIG. 1 shows a vertical lifting system for a robotic workstation according to this disclosure.

FIG. 2 shows a front-facing view from the operator’s perspective of the vertical lifting system for the robotic workstation of FIG. 1.

FIG. 3 is a side view from the perspective of 2-2 of FIG. 2.

FIG. 4 is an exploded view of the vertical lifting system for the robotic workstation of FIG. 1.

### DETAILED DESCRIPTION OF THE PREFERRED EMBODIMENTS

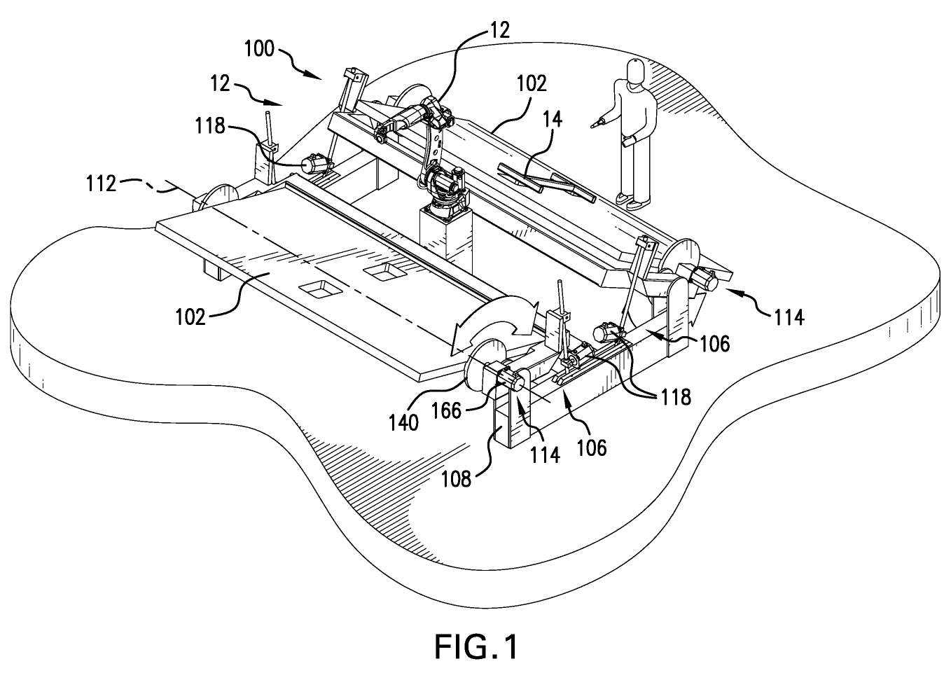

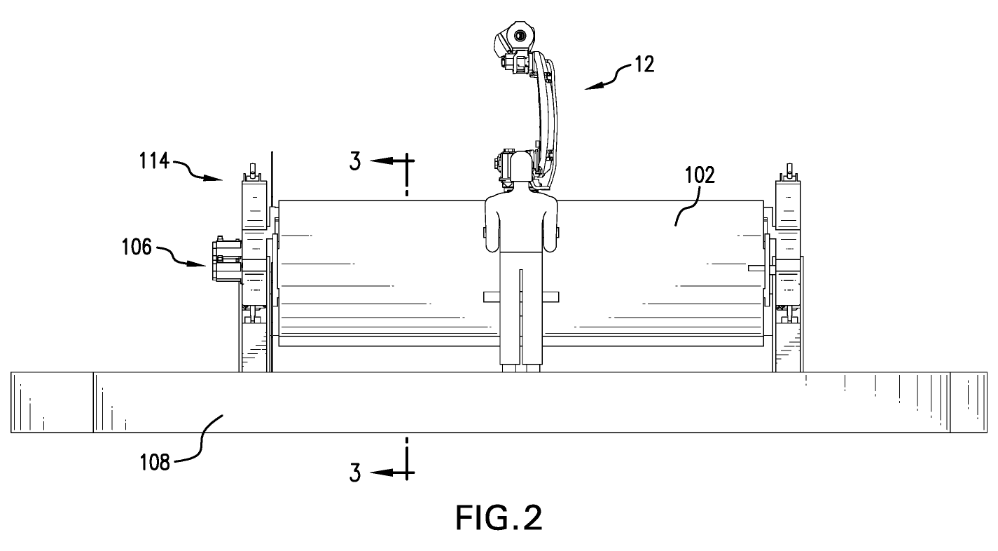

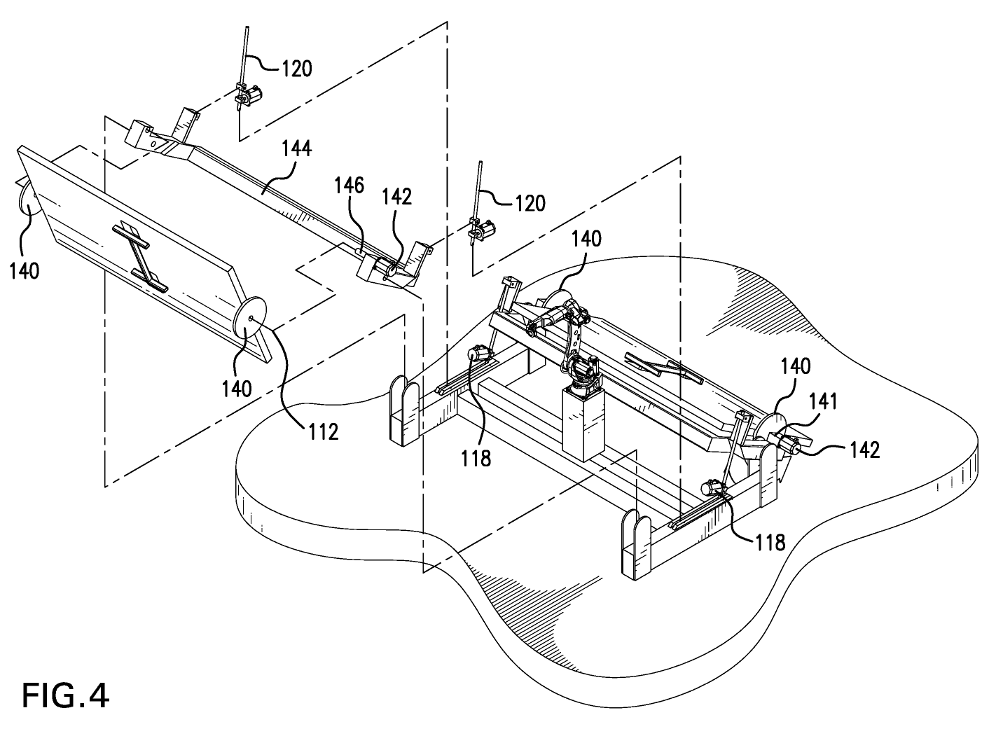

In accordance with one aspect of the present invention, vertical lifting system 100 for a robotic arm 12 is disclosed in FIGS. 1-4. Vertical lifting system 100 is designed to enhance the efficiency and flexibility of welding operations through a workpiece support table 102 configured for multi-axis positional adjustment. In the illustrated embodiment, robotic arm 12 includes robotic arm 12 equipped with a welding tool and workpiece support table 102 operatively positioned within the reach of robotic arm 12 for supporting workpieces 14 during welding and be able to rotate large parts and clear the floor. Vertical lifting system 100 is uniquely adapted to maneuver with two distinct degrees of freedom: a first rotational degree of freedom enabling controlled elevation by tilting of workpiece support table 102 via a driven linear mechanism 106 pivotally coupled to a frame 108, and a second rotational degree of freedom permitting rotational adjustment of workpiece support table 102 about a minor axis 112 through a motorized rotational system 114. This arrangement allows workpiece support table 102 to be dynamically positioned in a variety of orientations, optimizing access for robotic arm 12 and facilitating efficient loading, welding, and unloading of workpieces 14 in an automated manufacturing environment.

As shown, robotic arm 12 can be positioned in the middle between two vertical lifting systems 100 each with their own workpiece support tables 102. This allows one workpiece support tables 102 to be lowered towards the operator for loading or unloading a workpiece 14, while robotic arm 12 is carrying out its operations on another workpiece 14 on the other workpiece support tables 102.

Vertical lifting systems 100 has two rotational degrees of freedom. The first degree of rotational freedom of vertical lifting system 100 is configured to enable controlled elevation and tilting of workpiece support table 102 relative to frame 108. This functionality is achieved through driven linear mechanism 106, which is operatively coupled to workpiece support table 102 and frame 108 to impart a tilting motion about a bottom pivot point 110 and a top pivot point 111.

In the illustrated embodiment, the first rotational degree of freedom comprises an upper pivot and a lower pivot. The lower pivot is positioned outside the footprint of the workpiece support tables 102. Specifically, this means the lower pivot point is located external to the vertical projection of the table’s surface area onto the plane beneath it, meaning the axis about which workpiece support tables 102 tilts does not reside directly under workpiece support tables 102 itself. Instead, the lower pivot point is offset from the region immediately below workpiece support tables 102, ensuring that the tilting mechanism operates without encroaching into the space vertically aligned with the boundaries of workpiece support tables 102.

Driven linear mechanism 106 comprises a ball screw assembly 116 driven by a first servo motor 118. Ball screw assembly 116 includes a ball screw 120 and a cooperating nut 122, wherein ball screw 120 extends along a longitudinal axis and is rotatably supported at one end by a lower pivot mount 124 affixed to frame 108. Nut 122 is threadedly engaged with ball screw 120 and mechanically linked above workpiece support table 102 via a connecting bracket 126.

First servo motor 118 is operatively coupled to ball screw 120, such as through a direct drive connection or a gear train (not shown), to rotate ball screw 120 in a clockwise or counterclockwise direction. As first servo motor 118 drives ball screw 120, nut 122 translates linearly along the longitudinal axis of ball screw 120, thereby raising or lowering workpiece support table 102 via connecting bracket 126 and nut 122 and, consequently, tilting workpiece support table 102 about lower pivot point 110 on lower pivot mount 124 and about upper pivot point 111 on nut 122. Lower pivot mount 124 is defined by a pin and busing pivotally attaching an end of ball screw 120 to frame 108. Nut 122 also has a pin and bushing pivotally attaching the other end of ball screw 120 to bracket 126. As can be seen by comparing the two workpiece support tables 102, on the left side, when workpiece support table 102 is raised, bracket 126 is pivoted towards ball screw 120, and on the right side, when workpiece support table 102 is lowered, bracket 126 is pivoted away from ball screw 120.

Frame 108 serves as a rigid structural base for vertical lifting system 100 and may be constructed from welded steel or another suitably robust material to support the dynamic loads imposed during operation.

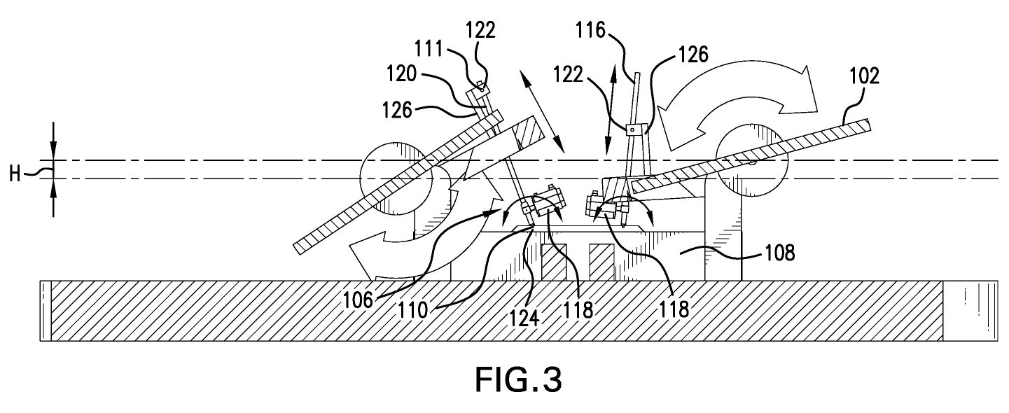

This configuration enables precise control over the elevation of workpiece support table 102 over a distance H, as shown in FIG. 3, allowing an operator to easily reach and mount a workpiece on workpiece support table 102 when in the lowered position and allowing a robotic arm 12 to reach across workpiece support table 102 when in the raised position.

Turning now to the second degree of freedom of vertical lifting system 100, this aspect is configured to permit rotational adjustment of workpiece support table 102 about minor axis 112. Minor axis 112 extends laterally across workpiece support table 102, enabling the table to rotate in a clockwise (CW) or counterclockwise (CCW) direction. This rotational capability allows workpiece support table 102 to be oriented either toward an operator for convenient loading and unloading of workpieces 14 or away from the operator and toward robotic arm 12 for optimized welding access, enhancing the flexibility of robotic arm 12 in an automated manufacturing environment.

In the illustrated embodiment, as shown in FIGS. 1-4, the second degree of freedom is facilitated by motorized rotational system 114, which comprises a pair of rotational mounts 140 positioned on opposite sides of workpiece support table 102, symmetrically aligned along minor axis 112. Rotational mounts 140 are disposed on a corresponding lateral sides of workpiece support table 102. Each rotational mount 140 is mechanically coupled to workpiece support table 102 and configured to support and rotate the table about minor axis 112.

The rotational range of workpiece support table 102, as depicted in FIG. 3, allows workpiece support table 102 to pivot between a first position lowered and oriented toward an operator and a second position, raised and oriented toward robotic arm 12. For example, on the left-hand side of FIG. 3, in the first position, workpiece support table 102 may be lowered and rotated towards the operator, facilitating ergonomic access for mounting or removing workpieces 14. In the second position, on the right-hand side of FIG. 3, workpiece support table 102 may be raised and rotated toward robotic arm 12, positioning workpieces 14 within the optimal reach of the welding tool. The synchronized operation of first servo motors 118 provides precise control over the elevation and second servo motor 142 provides precise control over the angular orientation of workpiece support table 102, each with the ability to stop at any intermediate position as dictated by the welding requirements or operator preferences.

Robotic arm 12 is positioned between a pair of vertical lifting systems 100, each equipped with a workpiece support table 102 configured for multi-axis positional adjustment. Vertical lifting systems 100 are uniquely adapted to operate in tandem, positioned on opposite sides of robotic arm 12, to optimize workflow efficiency in an automated welding environment. Each vertical lifting system 100 provides two degrees of freedom to its respective workpiece support table 102: a first degree of freedom enabling controlled elevation and tilting via a driven linear mechanism 106 pivotally coupled to a frame 108, and a second degree of freedom permitting rotational adjustment about a minor axis 112 via a motorized rotational system 114. This dual-table arrangement allows one workpiece support table 102 to be positioned for operator access while the other is oriented for robotic welding, enhancing productivity by enabling simultaneous loading, unloading, and welding operations.

Specifically, the configuration of vertical lifting systems 100 permits one workpiece support table 102 to be lowered and rotated toward an operator while the other is raised and rotated toward robotic arm 12. Through the first degree of freedom, driven linear mechanism 106 tilts a first workpiece support table 102 downward about a pivot point 110 by translating a nut 122 along a ball screw 120, reducing the elevation of workpiece support table 102 over a distance H to an operator-accessible position. Concurrently, motorized rotational system 114 rotates this table about minor axis 112 in a clockwise or counterclockwise direction using servo motor 142, orienting it toward the operator for convenient loading or unloading of workpieces 14. Simultaneously, the second workpiece support table 102 is raised by its driven linear mechanism 106, tilting it upward about its pivot point 110, and rotated by its motorized rotational system 114 toward robotic arm 12. This positions the second table within the optimal reach of robotic arm 12, allowing its welding tool to access workpieces 14 efficiently. The independent yet coordinated operation of the two vertical lifting systems 100 thus facilitates a continuous workflow, minimizing downtime in robotic arm 12.

While driven linear mechanism 106 is described in the illustrated embodiment as comprising a ball screw assembly 116 driven by first servo motor 118, alternative embodiments are contemplated to achieve the controlled elevation and tilting of workpiece support table 102 relative to frame 108 about pivot point 110. In one alternative, driven linear mechanism 106 may comprise a hydraulic actuator assembly, wherein a hydraulic cylinder replaces ball screw 120 and nut 122, with a piston rod extending from the cylinder and pivotally coupled to connecting bracket 126. The hydraulic cylinder is mounted to frame 108 via lower pivot mount 124 and powered by a hydraulic pump in lieu of first servo motor 118, extending or retracting the piston rod to tilt workpiece support table 102. In another embodiment, driven linear mechanism 106 may employ a rack-and-pinion system, wherein a linear rack is affixed to the underside of workpiece support table 102 and engaged by a pinion gear driven by first servo motor 118, with the rack’s linear motion guided by a track pivotally mounted to frame 108 at lower pivot mount 124. Each of these alternatives maintains the functionality of tilting workpiece support table 102 about pivot point 110, offering variations in cost, precision, or load capacity depending on the operational requirements of robotic arm 12. Other pneumatic and electric actuators are also contemplated.

Motorized rotational system 114 may employ a single servo motor 142 mounted to tie bar 144 on one lateral side, driving a central shaft 146 that extends through a single bearing-supported rotational mount 140 on the opposite side, with the shaft rigidly affixed to workpiece support table 102 to impart rotation without requiring dual motors. In another embodiment, a belt-and-pulley system could replace the direct shaft drive, wherein a servo motor 142 drives a pulley affixed to tie bar 144, connected by a tensioned belt to a second pulley integrated with rotational mount 140 on one side of workpiece support table 102, enabling CW or CCW rotation about minor axis 112. Alternatively, motorized rotational system 114 may utilize a worm gear mechanism, with a worm screw driven by servo motor 142 engaging a worm wheel affixed to workpiece support table 102 along minor axis 112, providing high torque and self-locking capabilities, with the worm screw assembly supported by tie bar 144. In yet another variation, a direct-drive rotary actuator could be employed, wherein a single annular motor encircles minor axis 112 and is mounted between tie bar 144 and workpiece support table 102, eliminating the need for shafts or external mounts by directly rotating the table. Each of these alternatives maintains the ability to rotate workpiece support table 102 toward the operator or robotic arm 12, offering options for simplicity, cost reduction, or enhanced precision in robotic arm 12.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. An apparatus for supporting workpieces in a robotic welding workstation, comprising:
a frame;
a workpiece support table operatively coupled to the frame and configured to support a workpiece within reach of a robotic arm;
a driven linear mechanism pivotally coupled to the frame and connected to the workpiece support table, the driven linear mechanism configured to tilt the workpiece support table, simultaneously, about a lower pivot point and an upper pivot point to raise and lower the workpiece support table relative to the frame; and
a motorized rotational system coupled to the workpiece support table, the motorized rotational system configured to rotate the workpiece support table about a minor axis extending laterally across the workpiece support table;
wherein the driven linear mechanism and the motorized rotational system cooperate to position the workpiece support table in a plurality of orientations for welding by the robotic arm.

2. The apparatus of claim 1, wherein the driven linear mechanism comprises a ball screw assembly including a ball screw pivotally supported by a lower pivot mount affixed to the frame, a nut threadedly engaged with a threaded shaft, and a connecting bracket comprising an upper pivot mount pivotally combining the nut to the workpiece support table.

3. The apparatus of claim 1, and further comprising a lower pivot mount combined to the frame with one end of the driven linear mechanism pivotally attached.

4. The apparatus of claim 3, and further comprising an upper pivot mount combined to the workpiece support table with the other end of the driven linear mechanism pivotally attached.

5. The apparatus of claim 2, and further comprising a first servo motor operatively coupled to the ball screw to drive the nut linearly along the threaded shaft, thereby tilting the workpiece support table about the lower pivot point and the upper pivot point.

6. The apparatus of claim 1, wherein the motorized rotational system comprises a rotational mount disposed on a lateral side of the workpiece support table, a shaft extending along the minor axis and coupled to the rotational mount on the workpiece support table, and a servo motor to rotate the shaft, thereby rotating the workpiece support table about the minor axis.

7. The apparatus of claim 5, further comprising a tie bar constraining opposite lateral sides of the workpiece support table to rotate about the minor axis.

8. A robotic workstation for processing workpieces, comprising:
a robotic arm configured to perform a processing operation on a workpiece;
workpiece support table proximate to the robotic arm for supporting the workpiece;
a vertical lifting system coupled workpiece support table for providing:
a first rotational degree of freedom elevating the workpiece support table by tilting the workpiece support table relative to robotic arm; and
a second rotational degree of freedom rotating the workpiece support table about an axis extending laterally across the workpiece support table.

9. The robotic workstation of claim 8, wherein the first rotational degree of freedom comprises a lower pivot that is positioned outside a footprint of the workpiece support table.

10. The robotic workstation of claim 8, and further comprising a frame and a lower pivot mount connected to the frame.

11. The robotic workstation of claim 10, and further comprising a driven linear mechanism operatively connected to the workpiece support table and the lower pivot mount.

12. The robotic workstation of claim 11, and further comprising an upper pivot mount combined to the workpiece support table with the other end of the driven linear mechanism pivotally attached.

13. The robotic workstation of claim 11, wherein the driven linear mechanism comprises a ball screw assembly including a ball screw rotatably supported by the pivot mount affixed to the frame, a nut threadedly engaged with a threaded shaft, and a connecting bracket linking the nut to the workpiece support table.

14. The robotic workstation of claim 8, and further comprising a rotational mechanism coupled to the workpiece support table, the rotational mechanism aligned with a minor axis extending laterally across the workpiece support table.

15. The robotic workstation of claim 14, wherein the rotational mechanism comprises a rotational mount disposed on a lateral side of the workpiece support table, a shaft extending along the minor axis and coupled to the rotational mount of the workpiece support table, and a servo motor to rotate the shaft, thereby rotating the workpiece support table about the minor axis.

16. The robotic workstation of claim 15, further comprising a tie bar constraining opposite lateral sides of the workpiece support table to rotate about the minor axis.

17. An apparatus for supporting workpieces in a robotic welding workstation, comprising:
a frame;
a workpiece support table operatively coupled to the frame and configured to support a workpiece within reach of a robotic arm;
a driven linear mechanism pivotally coupled to the frame at one end and pivotally coupled to the workpiece support table at the other end configured to tilt the workpiece support table about a lower pivot point and an upper pivot point to raise and lower the workpiece support table relative to the frame;
a motorized rotational system coupled to the workpiece support table, the motorized rotational system configured to rotate the workpiece support table about a minor axis extending laterally across the workpiece support table; and
wherein the driven linear mechanism and the motorized rotational system cooperate to position the workpiece support table in a plurality of orientations for welding by the robotic arm.

18. The apparatus of claim 17, further comprising a tie bar constraining opposite lateral sides of the workpiece support table, wherein the motorized rotational system is mounted to the tie bar to rotate the workpiece support table relative to the tie bar.

19. The apparatus of claim 18, and further comprising an actuator pivotally coupled to the frame at one end and pivotally coupled to the tie bar at the other end to raise and lower the workpiece support table relative to the frame.
